(19) United States
(12) Patent Application Publication
(10) Pub. No.: US 2019/0170535 A1
(43) Pub. Date: Jun. 6, 2019

(54) USING FINGER GENERATED MAP BOUNDING AS A TRIGGER FOR AN ACTION

(71) Applicant: GM GLOBAL TECHNOLOGY OPERATIONS LLC, Detroit, MI (US)

(72) Inventors: Xu Fang Zhao, LaSalle (CA); Gaurav Talwar, Novi, MI (US); Cody R. Hansen, Shelby Township, MI (US); Dustin H. Smith, Auburn Hills, MI (US)

(73) Assignee: GM GLOBAL TECHNOLOGY OPERATIONS LLC, Detroit, MI (US)

(21) Appl. No.: 15/833,099

(22) Filed: Dec. 6, 2017

(51) Int. Cl. G01C 21/36; G06F 3/0488; G06F 3/0484

(52) U.S. Cl. CPC G01C 21/3664; G01C 21/3614; G06F 3/04842; G01C 21/3617; G06F 3/0488

(57) ABSTRACT

In certain embodiments, methods, systems, and vehicles are provided for controlling information for a user. One or more sensors are configured to obtain one or more inputs from the user, the one or more inputs pertaining to a drawing made by the user on a display corresponding to a geographic region of interest for the user. A processor is configured to at least facilitate identifying the geographic region of interest based on the one or more inputs; and providing instructions for the providing of the information pertaining to one or more points of interest within the identified geographic region based on the one or more inputs.

### TECHNICAL FIELD

The technical field generally relates to the field of vehicles and other navigation and map-related applications and, more specifically, to methods and systems for utilizing finger generated inputs from users of the vehicle, or for other navigation and map-related applications.

### INTRODUCTION

Many vehicles, smart phones, computers, and/or other systems and devices include map information, for example for navigation purposes. However, in certain circumstances, it may be desirable for improved user inputs and processing thereof in certain situations.

Accordingly, it is desirable to provide improved methods and systems for receiving and processing user inputs, including finger generated inputs, for vehicles, smart phones, computers, and/or other systems and devices include map information, for example for navigation purposes. Furthermore, other desirable features and characteristics will become apparent from the subsequent detailed description of exemplary embodiments and the appended claims, taken in conjunction with the accompanying drawings.

### SUMMARY

In one exemplary embodiment, a method is providing for controlling information for a user. The method includes obtaining, via one or more sensors, one or more inputs from the user, the one or more inputs pertaining to a drawing made by the user on a display corresponding to a geographic region of interest for the user; identifying the geographic region of interest, via a processor, based on the one or more inputs; and providing information, via instructions provided by the processor, pertaining to one or more points of interest within the identified geographic region based on the one or more inputs.

Also in one embodiment, the step of obtaining the one or more inputs includes obtaining the one or more inputs pertaining to a drawing made by a finger of the user on a touch screen of the display, corresponding to the geographic region of interest for the user; and the step of identifying the geographic region of interest includes identifying the geographic region of interest based on the one or more inputs pertaining to the drawing made by the finger of the user on the touch screen of the display.

Also in one embodiment, the step of obtaining the one or more inputs includes obtaining the one or more inputs pertaining to a drawing of a polygon made by the finger of the user on the touch screen of the display, corresponding to the geographic region of interest for the user; and the step of identifying the geographic region of interest includes identifying the geographic region of interest based on the one or more inputs pertaining to the drawing of the polygon made by the finger of the user on the touch screen of the display.

Also in one embodiment, the step of obtaining the one or more inputs includes obtaining the one or more inputs pertaining to a drawing of an irregular polygon made by the finger of the user on the touch screen of the display, corresponding to the geographic region of interest for the user; and the step of identifying the geographic region of interest includes identifying the geographic region of interest based on the one or more inputs pertaining to the drawing of the irregular polygon made by the finger of the user on the touch screen of the display.

Also in one embodiment, the method further includes obtaining one or more second inputs corresponding to one or more criteria for possible points of interest; wherein the step of providing the information includes providing the information pertaining to the one or more points of interest within the identified geographic region based also on the criteria.

Also in one embodiment, the method further includes retrieving historical data pertaining to the user; wherein the step of providing the information includes providing the information pertaining to the one or more points of interest within the identified geographic region based also on the historical data.

Also in one embodiment, the steps of obtaining the one or more inputs, identifying the geographic region of interest, and providing the information are performed at least in part on a vehicle.

Also in one embodiment, the steps of obtaining the one or more inputs, identifying the geographic region of interest, and providing the information are performed at least in part on a smart phone.

In another exemplary embodiment, a system is provided for controlling information for a user. The system includes one or more sensors and a processor. The one or more sensors are configured to obtain one or more inputs from the user, the one or more inputs pertaining to a drawing made by the user on a display corresponding to a geographic region of interest for the user. The processor is configured to at least facilitate identifying the geographic region of interest based on the one or more inputs; and providing instructions for the providing of the information pertaining to one or more points of interest within the identified geographic region based on the one or more inputs.

Also in one embodiment, the one or more inputs pertain to a drawing made by a finger of the user on a touch screen of the display, corresponding to the geographic region of interest for the user; and the processor is configured to at least facilitate identifying the geographic region of interest based on the one or more inputs pertaining to the drawing made by the finger of the user on the touch screen of the display.

Also in one embodiment, the one or more inputs pertain to a drawing of a polygon made by the finger of the user on the touch screen of the display, corresponding to the geographic region of interest for the user; and the processor is configured to at least facilitate identifying the geographic region of interest based on the one or more inputs pertaining to the drawing of the polygon made by the finger of the user on the touch screen of the display.

Also in one embodiment, the one or more inputs pertain to a drawing of an irregular polygon made by the finger of the user on the touch screen of the display, corresponding to the geographic region of interest for the user; and the processor is configured to at least facilitate identifying the geographic region of interest based on the one or more inputs pertaining to the drawing of the irregular polygon made by the finger of the user on the touch screen of the display.

Also in one embodiment, the one or more sensors are configured to obtain one or more second inputs corresponding to one or more criteria for possible points of interest; and the processor is configured to at least facilitate providing the information pertaining to the one or more points of interest within the identified geographic region based also on the criteria.

Also in one embodiment, the processor is configured to at least facilitate: retrieving historical data pertaining to the user; and providing the information pertaining to the one or more points of interest within the identified geographic region based also on the historical data.

Also in one embodiment, the system is disposed at least in part on a vehicle.

Also in one embodiment, the system is disposed in part on a smart phone.

In another embodiment, a vehicle is provided. The vehicle includes a display, one or more sensors, and a processor. The one or more sensors are configured to obtain one or more inputs from a user via the display, the one or more inputs pertaining to a drawing made by the user on the display corresponding to a geographic region of interest for the user. The processor is configured to at least facilitate: identifying the geographic region of interest based on the one or more inputs; and providing instructions for the providing of information, via the display, pertaining to one or more points of interest within the identified geographic region based on the one or more inputs.

Also in one embodiment, the one or more inputs pertain to a drawing of a polygon made by a finger of the user on a touch screen of the display, corresponding to the geographic region of interest for the user; and the processor is configured to at least facilitate identifying the geographic region of interest based on the one or more inputs pertaining to the drawing of the polygon made by the finger of the user on the touch screen of the display.

Also in one embodiment, the one or more inputs pertain to a drawing of an irregular polygon made by the finger of the user on the touch screen of the display, corresponding to the geographic region of interest for the user; and the processor is configured to at least facilitate identifying the geographic region of interest based on the one or more inputs pertaining to the drawing of the irregular polygon made by the finger of the user on the touch screen of the display.

Also in one embodiment, the one or more sensors are configured to obtain one or more second inputs corresponding to one or more criteria for possible points of interest; and the processor is configured to at least facilitate: retrieving historical data pertaining to the user; and providing the information pertaining to the one or more points of interest within the identified geographic region based on the criteria and also on the historical data.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle having a control system for utilizing user inputs for map data for a navigation system for the vehicle and/or for one or more other applications, in accordance with exemplary embodiments;

FIG. 2 is a flowchart of a process for controlling the use of user inputs for map data, and that can be implemented in connection with the vehicle and the control system of FIG. 1, in accordance with exemplary embodiments; and

FIG. 3 depicts an illustration of an exemplary map display screen that can be utilized in connection with the vehicle and control system of FIG. 1 and the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

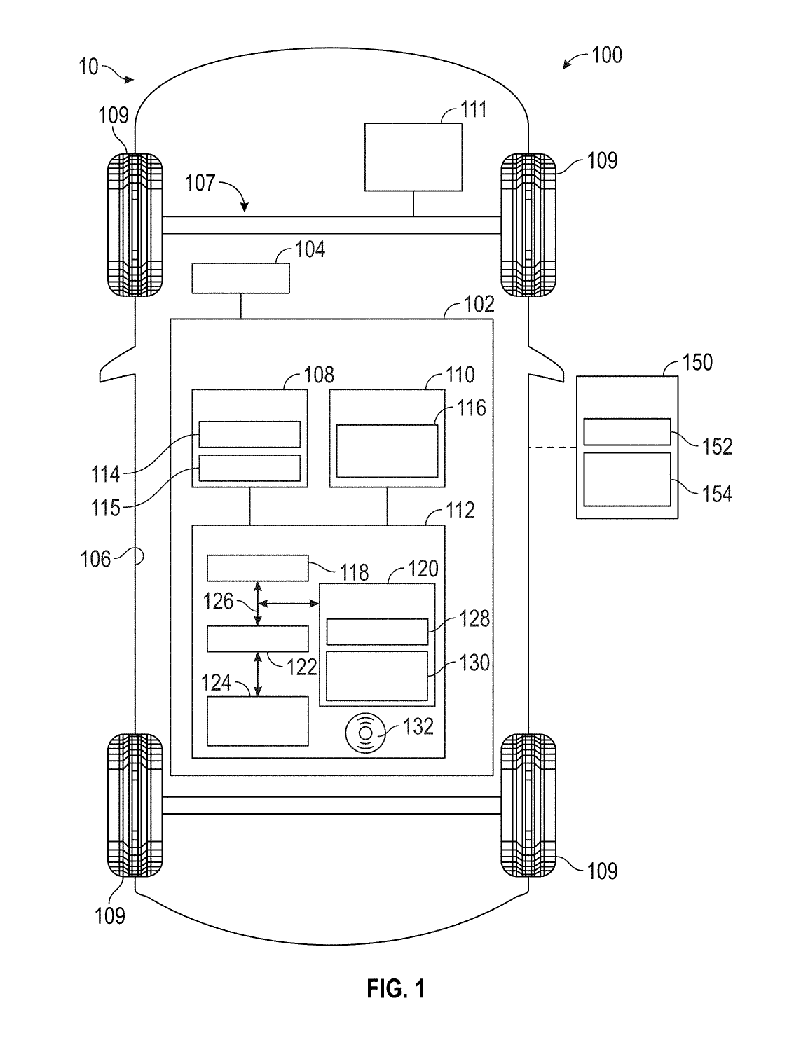

FIG. 1 illustrates a system 10 having a vehicle 100, according to an exemplary embodiment. As described in greater detail further below, the vehicle 100 includes a control system 102 and a display 104. Also as depicted in FIG. 1, in certain embodiments the system 10 also includes an electronic device 150. In certain embodiments, the electronic device 150 may be part of the vehicle 100 and/or disposed inside the vehicle 100. In certain other embodiments, the electronic device 150 may be separate and/or independent from the vehicle 100 and/or any other vehicle.

In various embodiments, the display 104 comprises a display screen and/or one or more associated apparatus, devices, and/or systems for providing visual information, such as map and navigation information, for a user. In various embodiments, the display 104 comprises a touch screen. Also in various embodiments, the display 104 comprises and/or is part of and/or coupled to a navigation system for the vehicle 100. Also in various embodiments, the display 104 is positioned at or proximate a front dash of the vehicle 100, for example between front passenger seats of the vehicle 100. In certain embodiments, the display 104 may be part of one or more other devices and/or systems within the vehicle 100. In certain other embodiments, the display 104 may be part of one or more separate devices and/or systems (e.g., separate or different from a vehicle), for example such as a smart phone, computer, table, and/or other device and/or system and/or for other navigation and map-related applications.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the control system 102 and/or display 104 may be implemented in connection with one or more different types of vehicles, and/or in connection with one or more different types of systems and/or devices, such as computers, tablets, smart phones, and the like and/or software and/or applications therefor.

In various embodiments, the vehicle 100 includes a body 106 that is arranged on a 108. The body 106 substantially encloses other components of the vehicle 100. The body 106 and the chassis 107 may jointly form a frame. The vehicle 100 also includes a plurality of wheels 109. The wheels 109 are each rotationally coupled to the chassis 107 near a respective corner of the body 106 to facilitate movement of the vehicle 100. In one embodiment, the vehicle 100 includes four wheels 109, although this may vary in other embodiments (for example for trucks and certain other vehicles).

A drive system 111 is mounted on the chassis 107, and drives the wheels 109. The drive system 111 preferably comprises a propulsion system. In certain exemplary embodiments, the drive system 111 comprises an internal combustion engine and/or an electric motor/generator, coupled with a transmission thereof. In certain embodiments, the drive system 111 may vary, and/or two or more drive systems 111 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, in various embodiments, the control system 102 includes one or more sensors 108, one or more location devices 110, and a controller 112. In addition, similar to the discussion above, while in certain embodiments the control system 102 is part of the vehicle 100 of FIG. 1, in certain other embodiments the control system 102 may be part of one or more separate devices and/or systems (e.g., separate or different from a vehicle), for example such as a smart phone, computer, table, and/or other device and/or system and/or for other navigation and map-related applications.

As depicted in FIG. 1, in various embodiments, the one or more sensors 108 generate sensor data, and provide the sensor data to the controller 112 for processing. As depicted in FIG. 1, the one or more sensors 108 include one or more input sensors 114 and one or more cameras 115. In various embodiments, the input sensors 114 detect a user's engagement of a display screen (e.g., of the display 104) via the user's fingers, including the user's drawing of a polygon corresponding to a geographic region of interest on the display screen when a map is presented on the display screen. As used throughout this Application, a “polygon” includes any continuous user gesture on a map and/or display screen which starts and ends at approximately the same point. In various embodiments, the region of interest comprises a geographic region of interest. In certain embodiments, the input sensors 114 comprise one or more capacitive touch sensors. Also in various embodiments, the input sensors 114 further include one or more other types of sensors to receive additional information from the user, such as criteria for desired points of interest within the region of interest (e.g., sensors of or pertaining to a microphone, touchscreen, keypad, or the like). In addition, in certain embodiments, one or more cameras 115 are utilized to obtain additional input data, for example pertaining to point of interests, such as by scanning quick response (QR) codes to obtain names and/or other information pertaining to points of interest (e.g., by scanning coupons for preferred restaurants, stores, and the like, and/or intelligently leveraging the cameras 115 in a speech and multi modal interaction dialog), and so on.

In various embodiments, the one or more location devices 110 generate location data, and provide the location data to the controller 112 for processing. As depicted in FIG. 1, the one or more location devices 110 include a receiver 116 (e.g., a transceiver) for obtaining information regarding a location in which the vehicle 100 is travelling. In certain embodiments, the receiver 116 is part of a satellite-based location system, such as a global positioning system (GPS). In certain other embodiments, the receivers 116 may participate in one or more other types of communication (e.g., cellular and/or other wireless vehicle to vehicle communications, vehicle to infrastructure communications, and so on).

In various embodiments, the controller 112 is coupled to the one or more sensors 108 and location devices 110. In certain embodiments, the controller 112 is also coupled to the display 104. Also in various embodiments, the controller 112 controls operation of the sensors 108, the location devices 110, and the display 104.

In various embodiments, the controller 112 receives inputs from a user that include the user's selection of a region of interest by the user drawing a polygon on the display 104 via one or more fingers of the user when a map is presented on the display 104. Also in various embodiments, the user's input as to the region of interest is detected via one or more of the sensors 114, and the controller 112 controls information provided to the user regarding possible points of interest within the region of interest based on the inputs provided by the user. As depicted in FIG. 1, the controller 112 comprises a computer system. In certain embodiments, the controller 112 may also include one or more sensors 108, location devices 110, other vehicle systems, and/or components thereof. In addition, it will be appreciated that the controller 112 may otherwise differ from the embodiment depicted in FIG. 1. For example, the controller 112 may be coupled to or may otherwise utilize one or more remote computer systems and/or other control systems, for example as part of one or more of the above-identified vehicle 100 devices and systems.

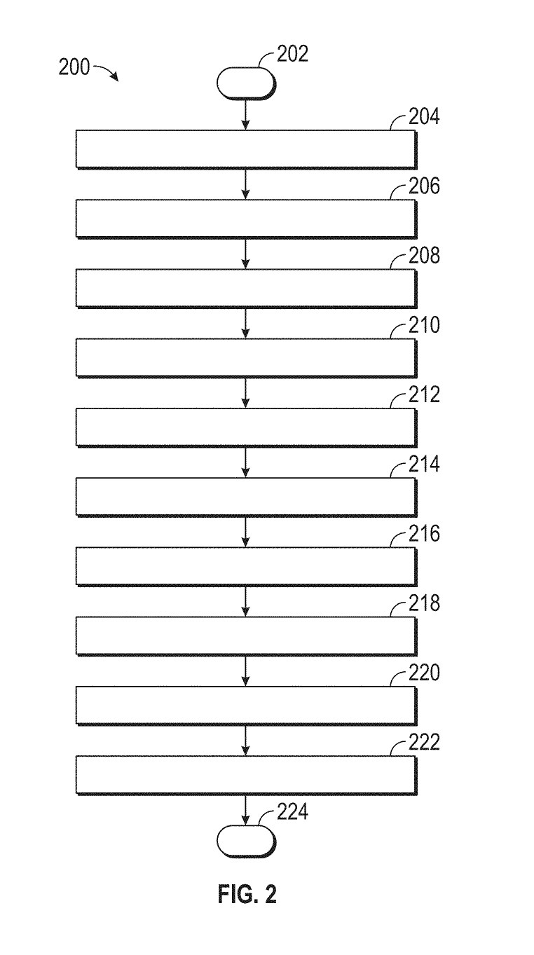

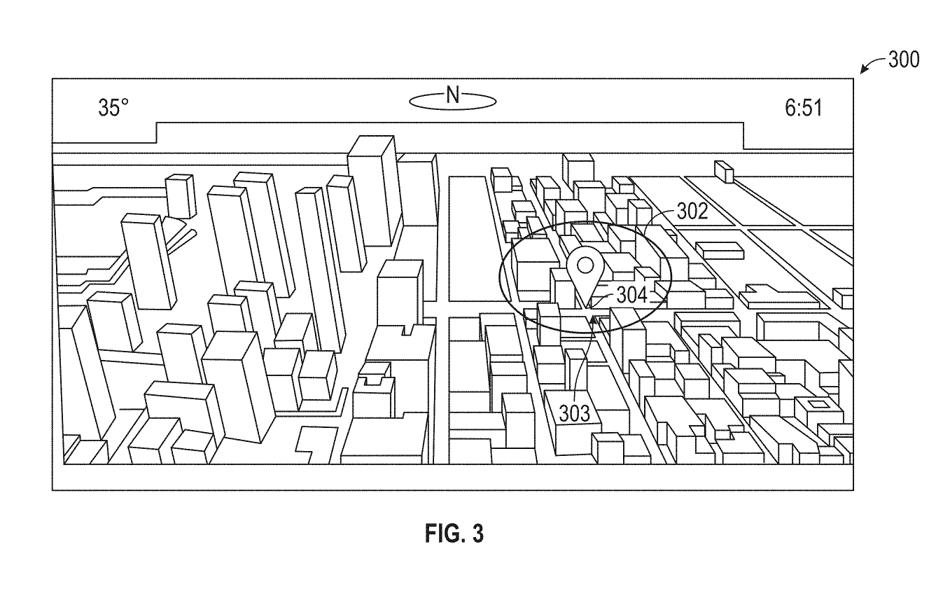

In the depicted embodiment, the computer system of the controller 112 includes a processor 118, a memory 120, an interface 122, a storage device 124, and a bus 126. The processor 118 performs the computation and control functions of the controller 112, and may comprise any type of processor or multiple processors, single integrated circuits such as a microprocessor, or any suitable number of integrated circuit devices and/or circuit boards working in cooperation to accomplish the functions of a processing unit. During operation, the processor 118 executes one or more programs 128 contained within the memory 120 and, as such, controls the general operation of the controller 112 and the computer system of the controller 112, generally in executing the processes described herein, such as the process 200 described further below in connection with FIG. 2 as well as the implementations discussed further below in connection with FIG. 3.

The memory 120 can be any type of suitable memory. For example, the memory 120 may include various types of dynamic random access memory (DRAM) such as SDRAM, the various types of static RAM (SRAM), and the various types of non-volatile memory (PROM, EPROM, and flash). In certain examples, the memory 120 is located on and/or co-located on the same computer chip as the processor 118. In the depicted embodiment, the memory 120 stores the above-referenced program 128 along with one or more stored values 130.

The bus 126 serves to transmit programs, data, status and other information or signals between the various components of the computer system of the controller 112. The interface 122 allows communication to the computer system of the controller 112, for example from a system driver and/or another computer system, and can be implemented using any suitable method and apparatus. In one embodiment, the interface 122 obtains the various data from the display 104, sensors 108, and/or location devices 110, and the processor 118 controls the providing of various navigation and/or map related information to the user based on the data.

Also in various embodiments, the interface 122, along with the sensors 108, location devices 110, and/or other vehicle systems, may be referred to as one or more input units that ascertain such data for the processor 118. In various embodiments, the interface 122 can include one or more network interfaces to communicate with other systems or components. The interface 122 may also include one or more network interfaces to communicate with technicians, and/or one or more storage interfaces to connect to storage apparatuses, such as the storage device 124.

The storage device 124 can be any suitable type of storage apparatus, including direct access storage devices such as hard disk drives, flash systems, floppy disk drives and optical disk drives. In one exemplary embodiment, the storage device 124 comprises a program product from which memory 120 can receive a program 128 that executes one or more embodiments of one or more processes of the present disclosure, such as the steps of the process 200 (and any sub-processes thereof) described further below in connection with FIGS. 2 and 3. In another exemplary embodiment, the program product may be directly stored in and/or otherwise accessed by the memory 120 and/or a disk (e.g., disk 132), such as that referenced below.

The bus 126 can be any suitable physical or logical means of connecting computer systems and components. This includes, but is not limited to, direct hard-wired connections, fiber optics, infrared and wireless bus technologies. During operation, the program 128 is stored in the memory 120 and executed by the processor 118.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 118) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 112 may also otherwise differ from the embodiment depicted in FIG. 1, for example in that the computer system of the controller 112 may be coupled to or may otherwise utilize one or more remote computer systems and/or other control systems.

As depicted in FIG. 1 and mentioned above, in certain embodiments the system 10 also includes an electronic device 150. As depicted in FIG. 1, the electronic device 150 include a display 152 and a control system 154. In various embodiments, the display 152 is similar in structure and functionality as the display 104 of the vehicle 100, and the control system 154 is similar in structure and functionality as the control system 102 of the vehicle 100. In various embodiments, various steps and functionality of the present Application, including those of the process 200 of FIG. 2 discussed below, may be performed by the electronic device 150 (including the display 152 and the control system 154 thereof), either in combination with the vehicle 100 and/or separate and/or independent from the vehicle 100.

FIG. 2 is a flowchart of a process for controlling the providing of information for a user, such as for a vehicle, based on inputs received from the user via one or more fingers of the user. The process 200 can be implemented in connection with the vehicle 100, the control system 102, and display 104 of FIG. 1, in accordance with exemplary embodiments. In addition, while the process 200 is discussed with reference to the vehicle 100 of FIG. 1, it will be appreciated that in certain embodiments the process 200 may be performed by the electronic device 150 (including the display 152 and the control system 154 thereof), either in combination with the vehicle 100 and/or separate and/or independent from the vehicle 100.

As depicted in FIG. 2, the process 200 begins at step 202. In certain embodiments, the process 200 begins when a vehicle drive or ignition cycle begins, for example when a driver approaches or enters the vehicle 100, or when the driver turns on the vehicle and/or an ignition therefor (e.g. by turning a key, engaging a keyfob or start button, and so on). In certain other embodiments, the process 200 begins when the display 104 of the vehicle 100 is activated. In certain embodiments, the steps of the process 200 are performed continuously during operation of the vehicle.

In various embodiments, location data is obtained (step 204). In various embodiments, the location data is obtained from the location device(s) 110 of FIG. 1 with respect to a current location of the vehicle 100 (and/or, in certain embodiments, a location of a smart phone, table, computer, and/or other device and/or for other navigation and map-related applications that are being utilized by the user). In certain embodiments, the location data is obtained via the receiver 116 of FIG. 1, for example as part of or from a satellite-based location system (e.g., a GPS system) and/or one or more other communication systems (e.g., via vehicle to vehicle and/or vehicle to infrastructure communications). Also in various embodiments, the location data is provided to the processor 118 of FIG. 1 for processing.

In various embodiments, first inputs are obtained (step 206). In various embodiments, sensor data is obtained from the input sensors 114 of FIG. 1 with respect to a user's drawings on a display. In certain embodiments, the first inputs are obtained from the input sensors 114 (e.g., capacitive touch sensors) regarding a user's engagement of a touch screen, for example for the display 104 of FIG. 1 (e.g., for the vehicle 100, and/or for a smart phone, tablet, computer, or the like, and/or for other navigation and map-related applications, in various embodiments). Also in certain embodiments, the user's drawing occurs on a display of a map that is presented for the user on the display. In various embodiments, the first inputs pertain to a drawing of a polygon (in certain embodiments, an irregular polygon) on the touch screen of the display 104 using one finger (or, in certain instances, multiple fingers) of the user to designate the region of interest for the user for searching for points of interest within the region of interest.

For example, as illustrated in FIG. 3 in accordance with certain non-limiting exemplary embodiments, a display screen image 300 is shown reflected user inputs in accordance with step 206. For example, as depicted in FIG. 3, the user has drawn an irregular polygon 302 on a map display with a finger of the user corresponding to the desired region of interest. It will be appreciated that the types of displays and drawings, and the like, may vary in different embodiments and implementations.

Returning to FIG. 2, also in various embodiments, second inputs are obtained (step 208). In certain embodiments, the second inputs of step 208 refer to a particular category of points of interest that the user is interested in visiting, such as restaurants in general, particular types of restaurants (e.g., fast food, pizza, fine dining, and so on), gas stations, vehicle repair stations, rest stops, grocery stores, historical sites, tourists destinations, and the like, among various other different types of points of interest and/or categories and/or characteristics pertaining thereto.

Also in various embodiments, during step 208 the second inputs may take the form of sensor data that is obtained from one or more input sensors 114 of FIG. 1 with respect to a user's criteria for points of interest within the region of interest. In certain embodiments, the second inputs are obtained from the same or similar input sensors 114 as step 206 (e.g., capacitive touch sensors) regarding a user's engagement of a touch screen, for example for the display 104 of FIG. 1, similar to step 206 (for example if the user uses the touch screen to provide the criteria of step 208). In other embodiments, the second inputs are obtained via microphones or sensors associated therewith (e.g., if the user provides the criteria verbally) and/or sensors associated with a keyboard or other input device (e.g., if the user types the criteria using such keyboard or other input device). In certain embodiments, the second inputs may be obtained via one or more cameras 115 of FIG. 1, for example, such as by scanning quick response (QR) codes to obtain names and/or other information pertaining to points of interest, and so on.

Also in various embodiments, the region of interest is recognized (step 210). In various embodiments, during step 210, the processor 118 of FIG. 1 recognizes the region of interest designated by the user in step 206 based on the first inputs obtained (e.g., as sensor data from the inputs sensors 114) from step 206. As noted above, in various embodiments, the region of interest comprises a geographic region of interest. In certain embodiments, the region of interest corresponds to a geographic region of interest that is in proximity to a current location of the vehicle 100 (e.g., as determined in step 204) and/or in proximity to a current path or plan of travel for the vehicle 100. In various embodiments, the processor 118 identifies coordinates of a map provided on the display corresponding to an interior of an irregular polygon drawn on the map by the user via the touch screen, as recognized by the input sensors, and for example using map data (e.g., from a map database as part of a navigation or map system, in various embodiments).

With reference again to FIG. 3, in various embodiments, a region 303 is recognized by the processor 118 as part of step 210. For example, in various embodiments, the region 303 is recognized as including the geographic coordinates (e.g., latitude and longitude) that correspond to an inner region defined by, and inside, the irregular polygon 302 of FIG. 3. As noted above, in various embodiments, the displays, drawings, and/or associated regions may vary in different embodiments.

With reference again to FIG. 2, also in various embodiments, historical data is retrieved (step 212). In various embodiments, the historical data comprises a history of preferences of the user (or of different users that may utilize the same vehicle or other device or system). For example, in certain embodiments, the historical data comprises a history of restaurants, service stations, grocery stores, tourist attractions, and/or other points of interest that the user (and/or the other users of the same vehicle, device, or system) have visited and/or expressed an interest in (e.g., within the past week, month, year, and/or other predetermined amount of time). In various embodiments, the historical data is generated based on prior searches by the user, prior stops as particular points of interest (e.g., as tracked via a satellite-based location device, such as a GPS device), and/or other preferences expressed by or on behalf of the user. Also in certain embodiments, the historical data is stored in the memory 120 of FIG. 1 as stored values thereof, and is retrieved and utilized by the processor 118 of FIG. 1.

One or more relevant points of interest are identified (step 214). In various embodiments, the processor 118 identifies one or more points of interest for the user based on the region of interest as recognized in step 210 (based on the first inputs of step 206), along with the user's expressed criteria for the points of interest from step 208 (i.e., corresponding to the second inputs of step 208) and the historical data of step 212. For example, in various embodiments, the processor 118 searches for points of interest that meet the criteria consistent with the second inputs of step 208 that also fall within aa boundary defined by the region of interest (e.g., within an interior region inside a polygon drawn by the user) as recognized in step 210 (which was based on the user's drawing of step 206). Also in certain embodiments, the processor 118 fine tunes the search based on the historical data of step 212 (e.g., by narrowing the search to particular points of interest and/or types of points of interest based on the historical data, and/or by placing higher priorities and/or rankings for certain points of interest based on factors that the user may be more likely to prefer based on the historical data, and so on). For example, if the user has visited a certain restaurant (or type of restaurant) recently (or more often), then such restaurant (or type of restaurant) may be weighted higher in the search, and so on.

By way of additional examples, in certain embodiments, a user may express a preference and/or criteria (e.g., via the second inputs of step 208) for a particular point of interest (or type of point of interest). Also in certain examples, the processor 118 may run a search of all points of interest within the particular region of interest that fit the criteria or preference expressed by the user. Also in certain embodiments, the list may be weighted and/or categorized based on a prior history of the user, for example as discussed above. Also in certain other embodiments, if the processor 118 cannot completely ascertain and/or understand the exact nature of the criteria or preferences from the user (e.g., if there is some ambiguity or uncertainty as to the language, and so on), then the processor may utilize the region of interest to help to narrow down the search and corresponding points of interest to help ascertain the user's intent and identify a preferred point of interest corresponding thereto.

With reference again to FIG. 3, in various embodiments, during step 214, one or more points of interest 304 are identified by the processor 118 within the region 303, and in accordance with the preferences and historical data associated with the user.

With reference again to FIG. 2, information is presented for the user (step 216). In various embodiments, the processor 118 provides instructions for the presentation of information via the display 104 of FIG. 1 (e.g., on a touch screen and/or other display screen thereof) pertaining to the identified point(s) of interest of step 214. In certain embodiments, during step 216, information may be presented as to one particular point of interest that best meets the criteria of the identification of step 214. In certain other embodiments, during step 216, information may be presented as to multiple points of interest (e.g., as presented via a list or on a map, and so on), each of which may meet the criteria of the identification of step 214. In various embodiments, the information regarding the point(s) of interest may include a name, description, address, reviews, menus, operating hours, and/or other data pertaining to the point(s) of interest.

Feedback is obtained from the user (step 218). In various embodiments, the input sensors 114 of FIG. 1 receive feedback from the user, for example as to whether the user approves of a suggested point of interest, and/or as to a selection of a preferred point of interest from a list and/or from a map, and so on.

In various embodiments, upon receiving the feedback, a final and/or updated presentation is provided for the user (step 220). In various embodiments the processor 118 provides instructions for the presentation of information via the display 104 of FIG. 1 (e.g., on a touch screen and/or other display screen thereof) pertaining to the selected point(s) of interest from step 218. In various embodiments, the information pertaining to the selected point(s) of interest may include, similar to the discussion above, a name, description, address, reviews, menus, operating hours, and/or other data pertaining to the selected point(s) of interest

Also in various embodiments, the selection is implemented (step 222). For example, in various embodiments, the processor 118 of FIG. 1 provides instructions (e.g., to the drive system 111 of FIG. 1) for the vehicle 100 to travel to the selected point(s) of interest as a destination for the vehicle. Also in certain embodiments, the process then ends at step 224. In various other embodiments, the process may instead return to step 204 and/or one or more other steps noted above, and/or may be re-started when the user is done visiting the selected point of interest, and/or when the vehicle 100 is turned on again in a driving mode (if turned off when visiting the selected point of interest), and so on.

Accordingly, the systems, vehicles, and methods described herein provide for controlling information for a user based at least in part on a geographic region of interest of the user, as expressed by the user in a drawing on a display. In various embodiments, the user provides a drawing of an irregular polygon on the display (e.g., on a touch screen) to indicate the region of interest, and the systems, vehicles, and methods identify points of interest within the region of interest. In certain embodiments, user-expressed preferences and/or point of interest criteria, along with historical data for the user, are utilized to identify and select relevant points of interest within the region of interest.

The systems, vehicles, and methods thus provide for a potentially improved and/or efficient experience for the user in finding and selecting points of interest. As noted above, in certain embodiments, the techniques described above may be utilized in a vehicle, such as an automobile, for example in connection with a touch-screen navigation system for the vehicle. Also as noted above, in certain other embodiments, the techniques described above may also be utilized in connection with the user's smart phones, tablets, computers, other electronic devices and systems, and/or for other navigation and map-related applications.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling information for a user, the method comprising:
obtaining, via one or more sensors, one or more inputs from the user, the one or more inputs pertaining to a drawing made by the user on a display corresponding to a geographic region of interest for the user;
identifying the geographic region of interest, via a processor, based on the one or more inputs; and
providing information, via instructions provided by the processor, pertaining to one or more points of interest within the identified geographic region based on the one or more inputs.

2. The method of claim 1, wherein:
the step of obtaining the one or more inputs comprises obtaining the one or more inputs pertaining to a drawing made by a finger of the user on a touch screen of the display, corresponding to the geographic region of interest for the user; and
the step of identifying the geographic region of interest comprises identifying the geographic region of interest based on the one or more inputs pertaining to the drawing made by the finger of the user on the touch screen of the display.

3. The method of claim 2, wherein:
the step of obtaining the one or more inputs comprises obtaining the one or more inputs pertaining to a drawing of a polygon made by the finger of the user on the touch screen of the display, corresponding to the geographic region of interest for the user; and
the step of identifying the geographic region of interest comprises identifying the geographic region of interest based on the one or more inputs pertaining to the drawing of the polygon made by the finger of the user on the touch screen of the display.

4. The method of claim 3, wherein:
the step of obtaining the one or more inputs comprises obtaining the one or more inputs pertaining to a drawing of an irregular polygon made by the finger of the user on the touch screen of the display, corresponding to the geographic region of interest for the user; and
the step of identifying the geographic region of interest comprises identifying the geographic region of interest based on the one or more inputs pertaining to the drawing of the irregular polygon made by the finger of the user on the touch screen of the display.

5. The method of claim 1, further comprising:
obtaining one or more second inputs corresponding to one or more criteria for possible points of interest;
wherein the step of providing the information comprises providing the information pertaining to the one or more points of interest within the identified geographic region based also on the criteria.

6. The method of claim 5, further comprising:
retrieving historical data pertaining to the user;
wherein the step of providing the information comprises providing the information pertaining to the one or more points of interest within the identified geographic region based also on the historical data.

7. The method of claim 1, wherein the steps of obtaining the one or more inputs, identifying the geographic region of interest, and providing the information are performed at least in part on a vehicle.

8. The method of claim 1, wherein the steps of obtaining the one or more inputs, identifying the geographic region of interest, and providing the information are performed at least in part on a smart phone.

9. A system for controlling information for a user, the system comprising:
one or more sensors configured to obtain one or more inputs from the user, the one or more inputs pertaining to a drawing made by the user on a display corresponding to a geographic region of interest for the user; and
a processor configured to at least facilitate:
identifying the geographic region of interest based on the one or more inputs; and
providing instructions for the providing of the information pertaining to one or more points of interest within the identified geographic region based on the one or more inputs.

10. The system of claim 9, wherein:
the one or more inputs pertain to a drawing made by a finger of the user on a touch screen of the display, corresponding to the geographic region of interest for the user; and
the processor is configured to at least facilitate identifying the geographic region of interest based on the one or more inputs pertaining to the drawing made by the finger of the user on the touch screen of the display.

11. The system of claim 10, wherein:
the one or more inputs pertain to a drawing of a polygon made by the finger of the user on the touch screen of the display, corresponding to the geographic region of interest for the user; and
the processor is configured to at least facilitate identifying the geographic region of interest based on the one or more inputs pertaining to the drawing of the polygon made by the finger of the user on the touch screen of the display.

12. The system of claim 11, wherein:
the one or more inputs pertain to a drawing of an irregular polygon made by the finger of the user on the touch screen of the display, corresponding to the geographic region of interest for the user; and
the processor is configured to at least facilitate identifying the geographic region of interest based on the one or more inputs pertaining to the drawing of the irregular polygon made by the finger of the user on the touch screen of the display.

13. The system of claim 9, wherein:
the one or more sensors are configured to obtain one or more second inputs corresponding to one or more criteria for possible points of interest; and
the processor is configured to at least facilitate providing the information pertaining to the one or more points of interest within the identified geographic region based also on the criteria.

14. The system of claim 13, wherein the processor is configured to at least facilitate:
retrieving historical data pertaining to the user; and
providing the information pertaining to the one or more points of interest within the identified geographic region based also on the historical data.

15. The system of claim 9, wherein the system is disposed at least in part on a vehicle.

16. The system of claim 9, wherein the system is disposed at least in part on a smart phone.

17. A vehicle comprising:
a display;
one or more sensors configured to obtain one or more inputs from a user via the display, the one or more inputs pertaining to a drawing made by the user on the display corresponding to a geographic region of interest for the user; and
a processor configured to at least facilitate:
identifying the geographic region of interest based on the one or more inputs; and
providing instructions for the providing of information, via the display, pertaining to one or more points of interest within the identified geographic region based on the one or more inputs.

18. The vehicle of claim 17, wherein:
the one or more inputs pertain to a drawing of a polygon made by a finger of the user on a touch screen of the display, corresponding to the geographic region of interest for the user; and
the processor is configured to at least facilitate identifying the geographic region of interest based on the one or more inputs pertaining to the drawing of the polygon made by the finger of the user on the touch screen of the display.

19. The vehicle of claim 18, wherein:
the one or more inputs pertain to a drawing of an irregular polygon made by the finger of the user on the touch screen of the display, corresponding to the geographic region of interest for the user; and
the processor is configured to at least facilitate identifying the geographic region of interest based on the one or more inputs pertaining to the drawing of the irregular polygon made by the finger of the user on the touch screen of the display.

20. The vehicle of claim 17, wherein:
the one or more sensors are configured to obtain one or more second inputs corresponding to one or more criteria for possible points of interest; and
the processor is configured to at least facilitate:
retrieving historical data pertaining to the user; and
providing the information pertaining to the one or more points of interest within the identified geographic region based on the criteria and also on the historical data.
